(19) United States
(12) Patent Application Publication
(10) Pub. No.: US 2005/0234370 A1
(43) Pub. Date: Oct. 20, 2005

(54) Breast milk expression system including massaging, expressing and containment features

(75) Inventors: Stephen C. Beal, San Diego, CA (US); Alan E. Jordan, Bend, OR (US); Anita M. Krajecki, Naperville, IL (US); Mary Beth Blue, San Antonio, TX (US); Oscar E. Hyman, Poulsbo, WA (US); Steven M. Harrington, Cardiff, CA (US); Carl Eugene Tedesco, Cardiff by the Sea, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Puronyx, Inc., San Diego, CA (US)

(21) Appl. No.: 10/666,838

(22) Filed: Sep. 17, 2003

Related U.S. Application Data
(60) Provisional application No. 60/411,604, filed on Sep. 17, 2002.

(51) Int. Cl. A61H 1/00

(52) U.S. Cl. 601/15; 601/152; 604/74

(57) ABSTRACT

Disclosed is a breast pump that supports a mother's and infant's breastfeeding needs and facilitates the lifestyle of the mother's choice. The breast milk expression system disclosed allows breastfeeding mothers to obtain milk comfortably, hands-free, conveniently and with discretion. The breast milk expression system disclosed includes at least two contact points which mimic hand-expression as well as infant suckling and effectively stimulate the secretion of oxytocin and prolactin to provide a healthy, safe and efficient breastfeeding session. The system disclosed has a gentle rhythmic massage means and is located a distance from the base of the nipple and massages in all quadrants of the breast. The rhythmic forward pressure is provided by a plurality of opposing pairs of expression bellows that move the milk from the lactiferous sinuses through the nipple pores, bio-mimicking the techniques of hand expression.

### CROSS-REFERENCES TO RELATED APPLICATIONS

This application claims priority to U.S. Provisional Application No. 60/411,604 (Attorney Docket No. 022010-000200US) filed Sep. 17, 2002 which is herein incorporated by reference for all purposes.

### FIELD OF THE INVENTION

The present disclosure relates to expressing milk from a human breast and, more particularly, relates to an alternative to hand or manual breast milk expression, which mimicks the suckling action of a breastfeeding infant.

### BACKGROUND OF THE DISCLOSURE

Most medical studies have proven the medical and psychological benefits for both the infant and the mother when a new infant is breastfed. Nevertheless, there are several situations wherein it is not practical nor medically advisable for the infant to be breastfed by the mother. In one example, if the mother is a working parent, then the mother and baby are separated during extended time periods throughout the day. In yet another example, the mother may be caring for several children and toddlers, as well as the infant, making it a challenge for the breastfeeding mother to accommodate her multiple needs and activities. In addition, there are medical situations wherein the infant may have been born prematurely and may be in a medical setting that separates the mother from the infant, or in other situations, the infant may have physical or neurological impairments that make breastfeeding impossible.

Therefore, other options need to be made available to nursing mothers so that both the infant and the mother may obtain the benefits of breastfeeding.

### SUMMARY OF THE DISCLOSURE

Disclosed is a portable battery powered breast pump that supports a mother's and infant's breastfeeding needs while facilitating the lifestyle of the mother's choice. The breast milk expression system disclosed allows breastfeeding mothers to obtain milk comfortably, hands-free, conveniently and with discretion. The breast milk expression system disclosed includes at least two contact points on the breast which mimic hand-expression and effectively stimulate the secretion of oxytocin and prolactin to provide a healthy, safe and efficient breast milk expression session.

The system disclosed has a gentle rhythmic massage means that is located in the area approximately 2 to 2½ inches from the base of the nipple and that massages in all quadrants of the breast. This is one of the areas where alveoli are located, and when stimulated with a light breast exam-like motion, physiological messages are sent through the female's body to the pituitary gland to release both oxytocin and prolactin into circulation. Next, the rhythmic forward pressure to the area 1 to 112 inches from the base of the nipple is provided by a series of inflatable rings, sections and a plurality of opposing pairs of expression bellows that move the milk from the lactiferous sinuses through the nipple pores, providing bio-mimicking techniques of hand expression, as well as bio-mimicking the suckling action that a baby's tongue performs to strip the milk from the lactiferous sinuses. This facilitates superior draining of the lactiferous sinuses, which is vital in maintaining milk volumes over extended periods of time. The action of the breast milk expression bellows is customizable by the mother in several categories, such as rhythm, rate and pressure. These features are programmable and can be saved for repeated use at future dates, which further enhances the mother's breastfeeding success with each breast milk expression session or episode.

The breast milk expression system is a discrete device that may be worn and operated on the woman's body under the woman's daily clothing and the operation is generally silent. The device is also comfortable, lightweight and adjustable for custom fit to each particular breastfeeding mother and provides a gentle massaging action, facilitating forward movement of the breast milk toward the nipple. In addition, the breast milk expression system is convenient, and provides hands-free operation with customizable program settings to elicit and enhance oxytocin release. The system also provides disposable single use, leakproof sterile or pre-sterile containment of the expressed milk, which, when placed in an appropriate container, provides direct delivery to the infant. In addition, the system's components are easy to clean and to sterilize when necessary.

These features and benefits allow a lactating mother to have control over her breast milk expression sessions and to choose when and where she expresses her breast milk. The system disclosed herein expresses breast milk in quantities equal to or in greater amounts than current known methods and, therefore, enhances breastfeeding success for nursing mothers.

### BRIEF DESCRIPTION OF THE DRAWINGS

The disclosure will now be described in greater detail with reference to the preferred embodiments illustrated in the accompanying drawings, in which like elements bear like reference numerals, and wherein:

FIG. 1 is a block diagram illustrating the primary components of the breast milk expression system according to the present disclosure;

FIG. 2 illustrates a front view of the breast milk expression system as shown on the breast;

FIG. 3 illustrates a side view of the breast milk expression system as shown on a breast;

FIGS. 3A through 3C illustrate the operation of the distal end of the breast milk expression system;

FIG. 4 illustrates a side view of the breast milk expression system as shown on a breast, with a close up view 4A.

FIGS. 5A and 5B illustrate a bellows bladder as a sub-component of the breast milk expression system of the present disclosure, wherein the bellows bladder is shown in a deflated mode, wherein the breast is not deformed, and wherein the bellows bladder is shown in an inflated mode, shown exerting pressure on the breast tissue;

FIGS. 6A and 6B illustrate an additional embodiment of the bellows bladder according to the breast milk expression system of the present disclosure, wherein the bellows bladder is hinged at a forward or interior position in relation to the base of the breast, and wherein the hinged bellows bladder is shown first in a deflated position and next the hinged bellows bladder is shown in an inflated position, illustrating how the hinged bellows bladder, according to the present disclosure, may be used to exert pressure on the breast at a particular location so as to facilitate the forward expression of breast milk through the nipple;

FIG. 7 is a top plan view of a component of the breast milk expression system according to the present disclosure, wherein a massaging means, as well as an expression means, are located on the component, with a plurality of channels shown that may be utilized to inflate and deflate the particular component selectively;

FIG. 8 illustrates a top plan view of the breast milk expression means, as well as the massaging means, according to the present disclosure;

FIG. 9 is a top plan view of the breast milk expression means, as well as the massaging means, according to the present disclosure;

FIG. 10 is an elevational side-view showing a rigid dome cover over the expression means and the massaging means;

FIG. 11 is a perspective top plan view of the massaging and expression means, according to the present disclosure, wherein the expression means are shown in the deflated position;

FIG. 12 is a perspective top plan view of the massaging and expression means, according to the present disclosure, wherein the expressions means are shown in an inflated position, and this embodiment shown the expression means does not utilize a hinged bellows as described above;

FIG. 13 illustrates a screen shot of the software cycling program that is used to regulate the inflation and deflation of the appropriate massaging and breast milk expression bladders according to the present disclosure;

FIG. 14 illustrates timing diagrams for the breast milk expression system, as well as the massaging system, and as described in the detailed description below, the cycles and times are independently adjustable and may be saved or recorded based upon a successful breast milk expression session, so that the successful patterns may be repeated at a future date; and

FIG. 15 is a schematic representation of the components used to operate the breast milk expression system, according to the present disclosure.

### DETAILED DESCRIPTION OF THE INVENTION

The present disclosure is a breast milk expression system, which includes massaging, expressing and containment features, which all may be incorporated discretely into a garment such as a bra or other breast supporting garment that is adapted to be worn by a female who desires to express breast milk. The breast milk expression system, as disclosed herein, may be operated and utilized independent from the use of the female's hands, so as to provide essentially a hands free operation. As will be further described below, the breast milk expression system may be operated to express milk from either the left breast or the right breast independently, or both breasts simultaneously as desired by the user.

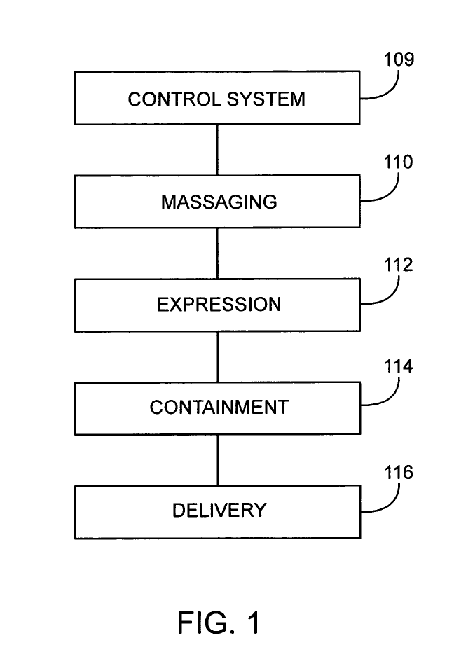

As shown in FIG. 1, the breast milk expression system of the present disclosure includes several sub-components and features, including a control system 109, a massaging sub-component 110, an expression sub-component 112, a containment sub-component 114, and a delivery mechanism 116, wherein each of these sub-components and features will be further described in greater detail below.

The functional requirements of the breast milk expression system described herein includes a plurality of massaging means that are located behind the areola, and generally in areas of the breast that are posterior to the nipple and areolar tissue, and a breast milk expression means, with the massaging and expression means being separately controlled. The massaging means is capable of cycling from a posterior position toward an anterior position on the breast, that is to say from the base of the breast to the areola, or back to front, circumference (outermost to areola) to encourage forward movement of the breast milk. The breast milk expression means includes a peristaltic wave, which provides bio-mimicry of hand expression, which further encourages forward movement of breast milk and mimics an infant sucking on the female's breast. This peristaltic wave cycles at an adjustable rate of 1 cycle every 1.0 to 1.5 seconds mimicking non-nutritive and nutritive infant suckling. In addition, the negative pressure created by the breast milk expression system may be approximately 120 to 180 milliliters of mercury pressure (the mm-Hg) for ideal breast milk expression, however, the negative pressure may be increased as high as 225 to 250, as required to provide maximum success during each milk expression session. In addition, the breast milk expression means may be accomplished by the application of positive pressure upon the breast tissue and with an adjustable intensity or depth of compression to provide maximum milk expression as may be required per session while maintaining optimal comfort.

In addition, the inner core of the massaging and expression sub-components are made of a non-allergic soft silicone-type elastomeric material so as to provide a comfortable yet conforming fit to the contour of the wearer's breast. As will be further described below, the breast milk expression system of the current disclosure provides programmable operational features, so that a successful expression system may be recorded, saved and repeated by the user so as to provide optimal breast milk volumes in the quickest and most efficient time frame. Further, as will also be described below, the sub-components of the present expression system maintains the highest nutrient quality of the expressed breast milk, providing physiological and psychological benefits to both the infant and to the mother. Further yet, the expression system of the present disclosure provides a sterile or pre-sterile, leak proof collection, storage and feeding containment unit, which interfaces and is used with an optimal infant feeding system seamlessly, and assures the highest quality of breast milk's nutrient content, and further facilitates no bacterial or bio-contamination potential of the expressed breast milk during the collection, storage or feeding phases.

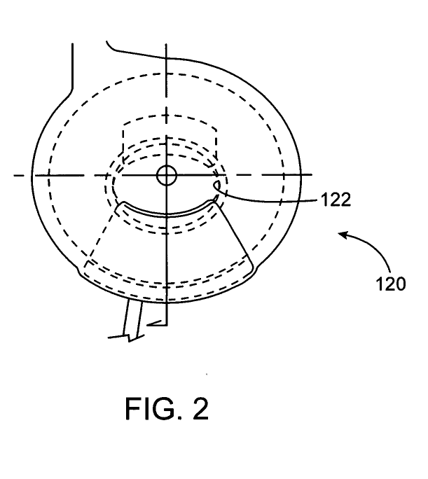

FIG. 2 illustrates a front view of the breast milk expression device resting on one breast. The expression device 120 has an opening 122 which allows the nipple portion of the breast to extend into the opening 122.

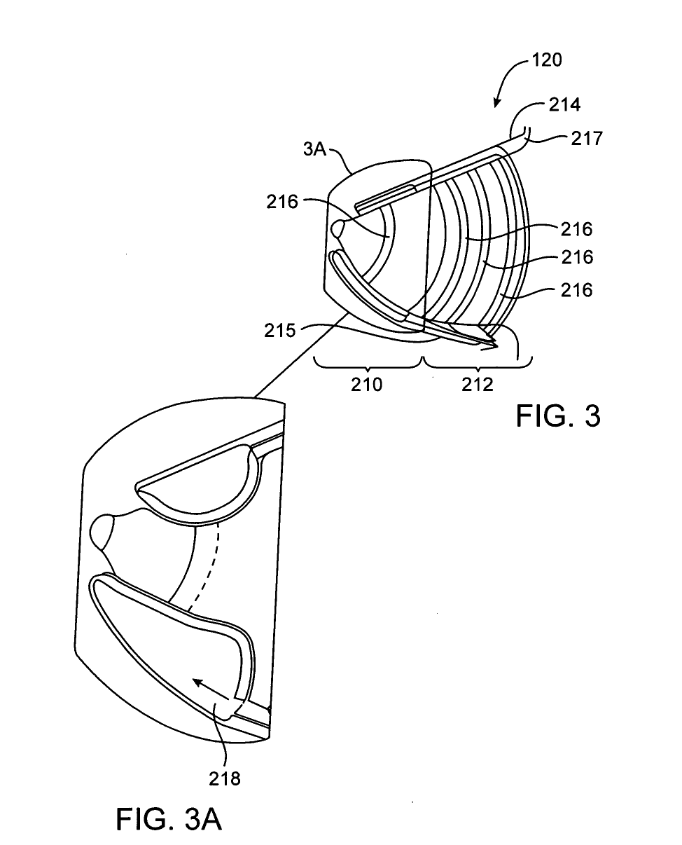

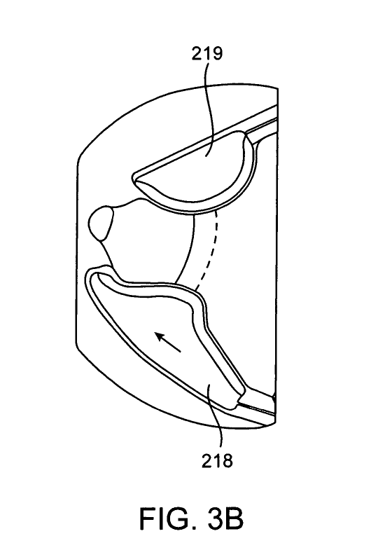

FIG. 3 illustrates one embodiment of the massaging means and the expression means, according to the present disclosure. As shown in the side view of FIG. 3, the expression means is shown in Section 210, and the massaging means is shown in Section 212. Both the expression means and the massaging means are supported by a bra cup 214, as typically used in a nursing bra. The massaging means 212, according to the present disclosure, improves the outcome of breast milk expression, because, as documented in research outcomes, massaging the posterior portion of the breast is beneficial in eliciting the release of oxytocin triggering a natural milk ejection reflex. If oxytocin is not released, milk ejection reflex will not occur and this presents uncomfortable as well as potential medical complications such as sore breasts, sore nipples, and which, without prompt attention, may generate frustration, discouragement and ultimately impede the milk supply to the infant. After the massaging means 212 encourages milk to flow, the expression means 210 expresses the milk.

As shown in FIGS. 2, 3, 4, 7, 8, 9, 10, 11, and 12, the massaging means may comprise a plurality of annular rings that are inflated and deflated by use of an air or vacuum pump or similar means. The annular rings are bladders, and in one example include a front bladder, a central bladder and a rear bladder in which each bladder is independently controlled and operated by a control system which will be further described below. The massaging means 212 is operated prior to the expression means and, therefore, the expression means 210 is in an idle state while the massaging means 212 is being activated to elicit milk ejection reflex. After milk ejection reflex has occurred, the expression means 210 is then operated to simulate a peristaltic wave which simulates the sucking action of an infant, including the use of the infant's palate, as well as the infant's lateral and central portions of the tongue.

As shown in FIG. 3, the device includes a conical cup 215. The cup includes a plurality of annular channels 216 which allow for the passage of air. The annular channels 216 are fed by channels 217. In the embodiment shown, the massaging portion 212 includes three annular channels, a rear annular channel, a central annular channel, and a forward annular channel.

As shown in Views 3A-3C, the expression means 210 utilizes a peristaltic wave that begins at View A at the rear of the expression means 210 as shown by air inflating a bladder 218. At View 3B, the peristaltic wave continues through the center section of the bladder 218 and the upper opposing bladder 219 inflates so as to provide opposing pressure at the appropriate location of the breast. The peristaltic wave continues at View 3C with air expanding into the end section of bladder 218. In the last step, the bladders 218 and 219 deflate for 0.5 seconds, then the steps are repeated. This peristaltic wave provides a bio-mimicry of the infant's suckling action to remove milk and takes full advantage of the milk ejection reflex that is elicited during the massaging action by the massaging means. It should be noted that the breastfeeding mother may continue to operate the massaging means while the expression means is operating or may slow down the rhythm or intensity of the massaging means, or simply turn the massaging means off while the expression means is operating, since the massaging means and the expression means are independently pre-programmed, operated and controlled by the control system and the user. The shape of bladder 218 during inflation may be controlled by the thicknesses of the bladder wall.

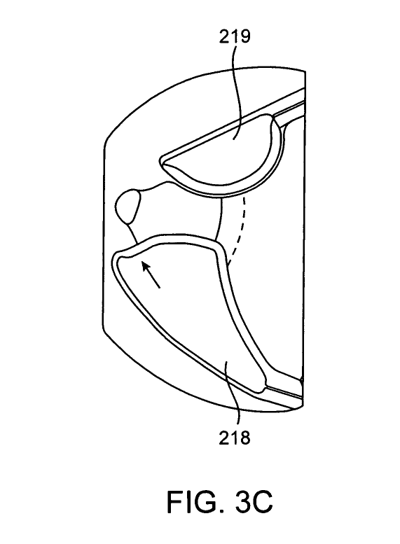

FIG. 4 and View 4A illustrate the air channels 217 that are utilized to inflate and deflate the annular rings and bladders as described.

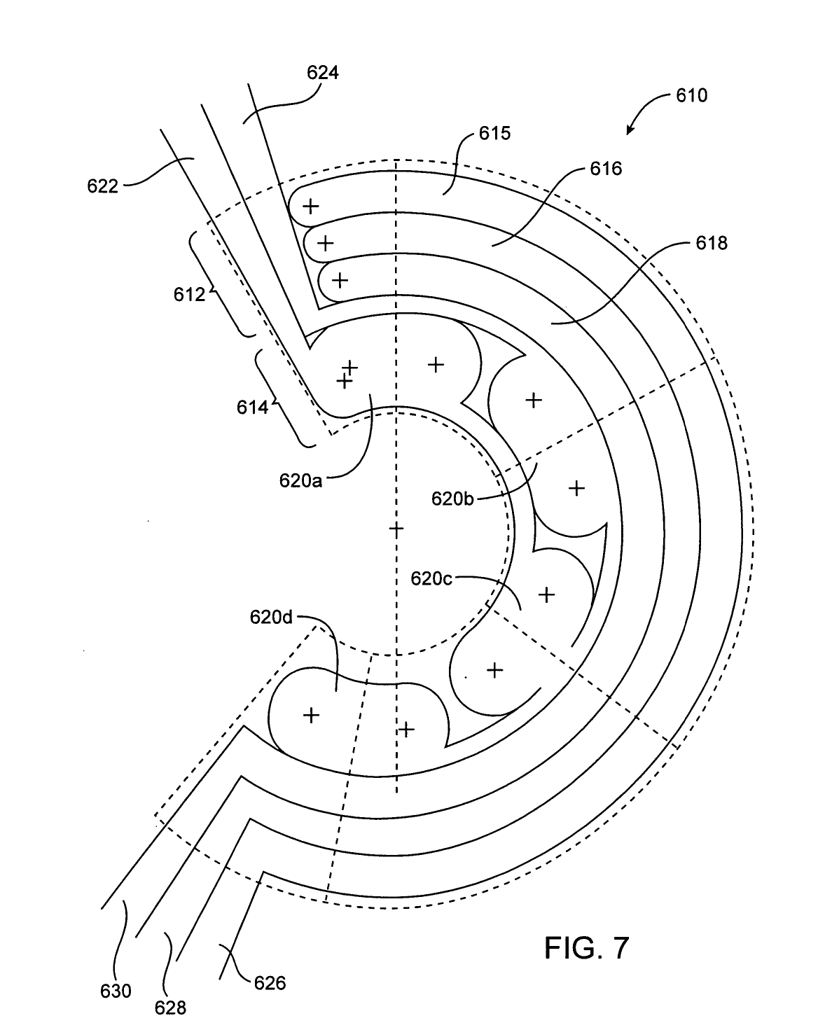

In one embodiment shown in FIGS. 8, 9 and 10, the massaging means are shaped as rectangular portions 632, so as to simulate fingertips. The massaging components have rounded end rectangles and are approximately 2.0 cm wide, 2.0 cm to 3.0 long, and 2.0 cm apart, and are located near the distal or widest edge of the breast receptacle portion of the expression system. The massaging rectangular-shaped fingertips provide a compression depth for each massaging rectangle so as to apply pressure to the breast while moving the breast tissue forward with an estimated range of motion of approximately 1.0 cm to 4.0 cm, measured from the skin surface while it rests. In another embodiment, each massage rectangle is bellowed or bifurcated so as to create a more natural forward stroking motion sensation. The rectangles each fill simultaneously or in a sporadic manner with intermittent sequencing to create a massaging sensation on the base circumference portion of the breast. This action also bio-mimics the mother's massaging of the breast tissue as the first component of hand expression, wherein she incorporates circular and stroking motions and moves her hands to various areas around the circumference of the breast tissue to ensure complete massage. Once the massaging rectangular-shaped fingertips are full, in which each of the bladders fills within 0.5 to 1.0 seconds, they hold inflation for a program time interval and the programmable hold phase will have the ability to vary, for example, from approximately 1.0 to 3.0 seconds in length. The massaging means further may be deflated and re-inflated for example from within 0.0 to 0.5 seconds. With the pattern having the ability to cycle or repeat for example for 1.0 to 5.0 minutes, however, the breastfeeding mother may override the cycle at any time once she has elicited milk ejection reflex. The massaging pattern then may spontaneously move into an expression pattern unless manually overridden by the breastfeeding mother. The massaging pattern may be individually programmed by the mother to maximize effectiveness and response of a milk ejection reflex or a successful pattern may be saved and stored for future use.

The massaging means of the present disclosure provides a stimulation of nerves on the breast tissue above the alveoli and ductal structures and send nerve messages via the ascending central nervous system to stimulate the hypothalamus gland. The hypothalamus is responsible for stimulating the posterior pituitary gland to secrete oxytocin, and which causes contraction of the many myoepithelial cells causing the secreted milk to rush through the breast's ductal structures ultimately collecting in the terminal end of the ductal structures (near the nipple), all of which is a called the milk ejection reflex.

At the conclusion of the massaging phase, the massaging means have elicited the milk ejection reflex causing the movement of milk from the alveoli through the ductal structures into the lactiferous sinuses where the breast milk can then be drawn through the nipple bio-mimicking both hand expression and the suckling action of the infant.

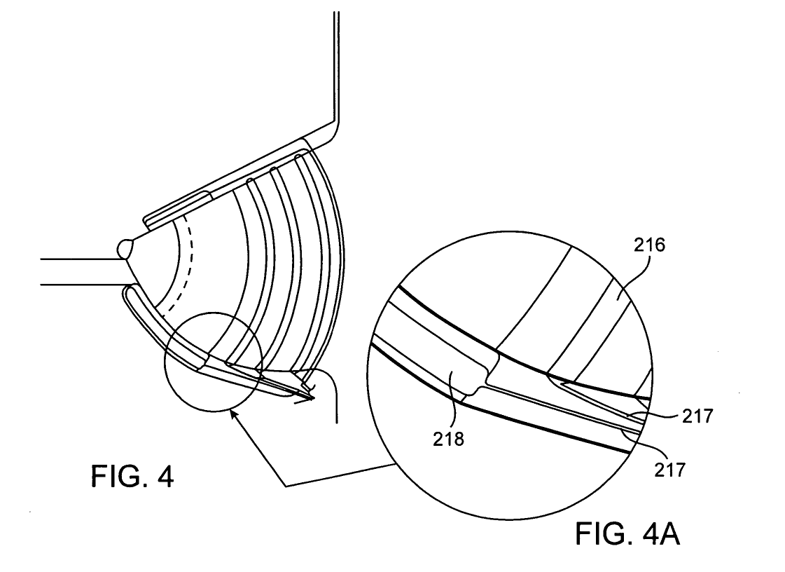

The expression means 210 may take the configuration shown in FIGS. 2, 3, and 4 with opposing members 218 and 219 providing bio-mimicry of hand expression and the infant's palate and tongue motions to stimulate a peristaltic wave. In the alternative, an alternative embodiment is found in FIGS. 5, 6, 7 and 8, wherein two tiers of opposing inflatable bellows bladders are provided to express milk from the breast. In this embodiment, a pliable cuff is wrapped around the breast and held in place by fastening means and/or the bra. As shown in FIG. 4, the bellows bladder is shown housed in a breast receptacle and deflated wherein very little, if any, positive pressure is exerted onto the breast tissue. However, when the bellows bladder 410 is inflated, comfortable positive pressure is applied to the breast to express milk from the nipple. The bellows each pivot from one point or plane.

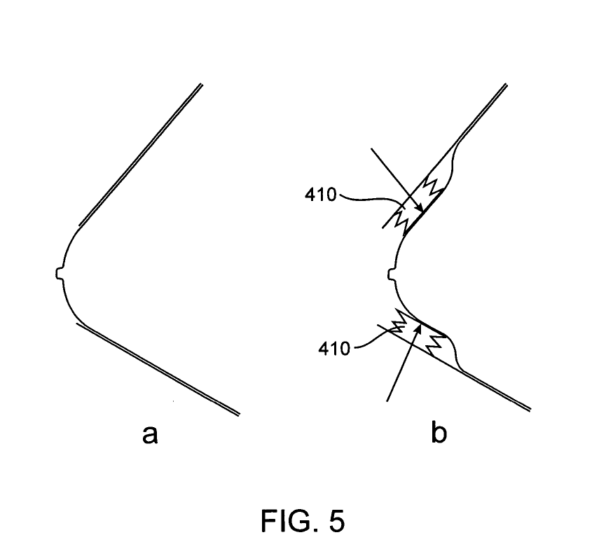

As shown in FIG. 6, another embodiment of a bellows bladder is a hinged bellows bladder, wherein the bellows bladder is hinged at the anterior or forward portion of the breast receptacle, so as to provide leverage and a forward exertion pressure on the breast as the hinged bellows bladder 510 is inflated. The leverage provided by the hinged bellows bladder provides additional force that may be exerted against the breast and more efficiently moves the breast milk forward internally in the breast through the nipple for expression.

The bellows are designed to hold the nipple in a channel-like position to mimic the sides of an infant's tongue that curls upward to hold the nipple channeled and secure in the center of the mouth during a breastfeeding session.

In one embodiment, the bellow may include a rolling ball within the bellow with two different size ball ends generally shaped like a dumbbell 511 located within the rotating ball. As the dumbbell is rotated end-over-end located within the bellow, it creates the sensation of the peristaltic motion of the infant's tongue stripping the milk from the ductal structures through the mother's nipple. The dumbbell component rotates at a rate of one second per rotation, then holds with the largest ball in the upward position for 0.5 seconds. Rotation is toward the direction of the tip of the nipple.

The tongue expresser, as shown in FIG. 8 has a rotating motion, and the remaining expression bellow is located at the top of the breast receptacle and may be filled and hold a constant pressure against the upper area of the nipple tissue. This simulates the palate of the infant's mouth as it secures the nipple placement during the stripping motion of the tongue and mimics the mother's thumb position against the upper side of the nipple and areolar tissue during hand expression. This creates a firm structure for the tongue bellow to move against compressing the mother's nipple and areolar tissue between the two surfaces and facilitates complete stripping of the available milk in the terminal ductal structures of the breast.

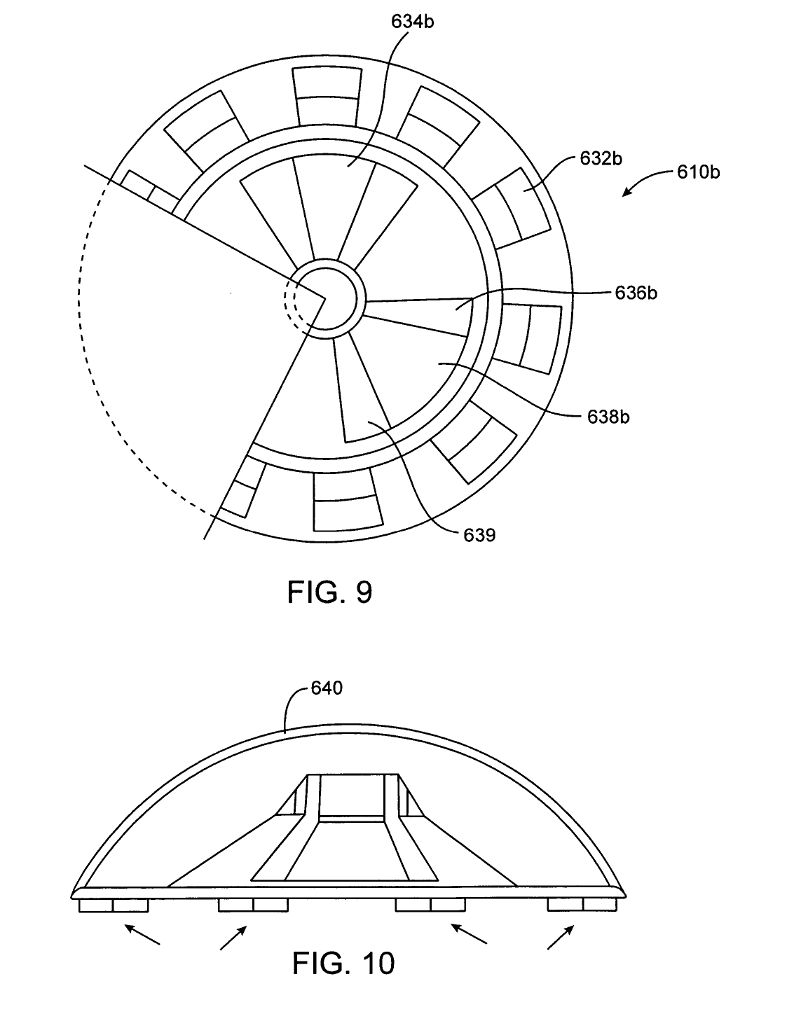

As shown in FIG. 10 by way of example, a rigid dome cover 640 creates a sealed mechanism while worn and also may create a vacuum around the nipple, similar to the infant's mouth when properly sealed to the mother's breast tissue. This also facilitates the extraction of milk from the breast structure. Other sealing configurations may be used as well.

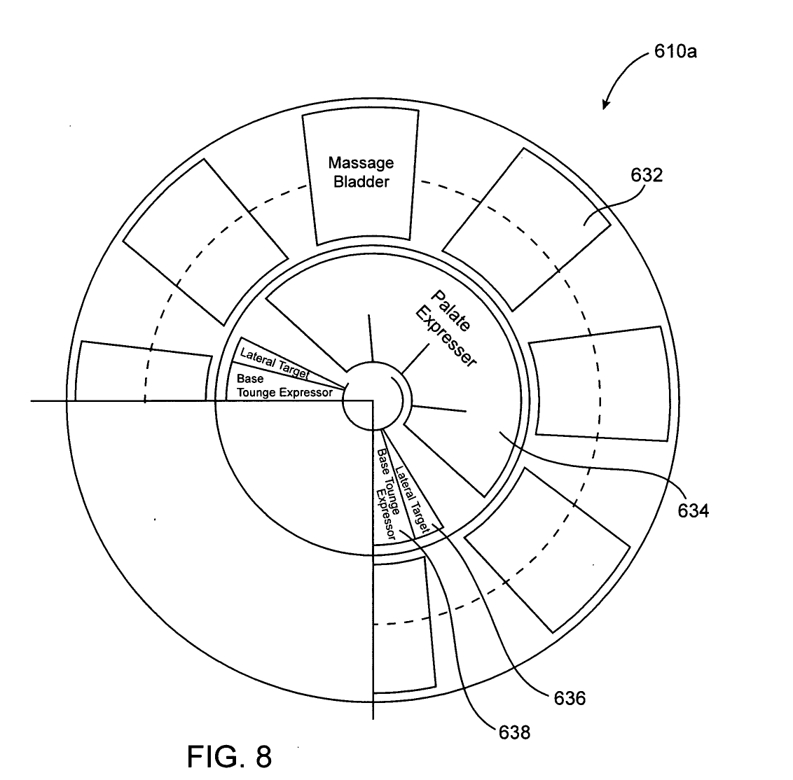

As shown in FIGS. 9 and 10, the overall breast receptacle size is approximately 16.0 cm and the overall height of the breast receptacle is approximately 3.0 cm for the average breast size. The overall height of the rigid dome cover is approximately 5.25 cm and the nipple ring bladder opening has a height of approximately 0.5 cm with a dimension of 3.0 cm at rest, and a dimension of 2.0 cm while inflated, for the average breast size. The palatal stabilizer 634 has three sections to provide for a natural contour with a length of approximately 3.5 cm, with the width at the widest end being approximately 6.0 cm and the width at the narrowest end being approximately 2.0 cm. The tongue expresser 638 may include three sections to provide for natural peristalsis with a length of approximately 3.5 cm and with a width at the widest end of approximately 3.5 cm, and a width at the narrowest end of approximately 0.5 cm. The massage component may include eight bifurcated massage bladders 632 with a width of approximately 2.0 cm and a height of approximately 2.5 cm, with the space between the bladders being approximately 2.0 cm. The components are inflated and deflated by air passing through the air channels connected to the components. Lateral tongue stabilizer 639 work with the tongue expresser.

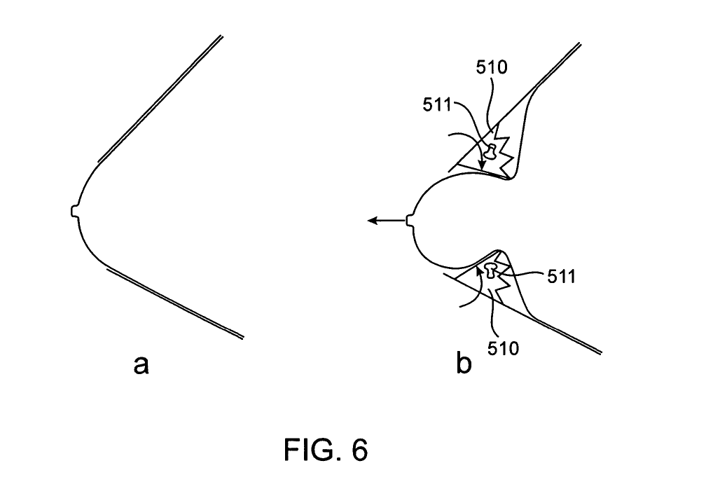

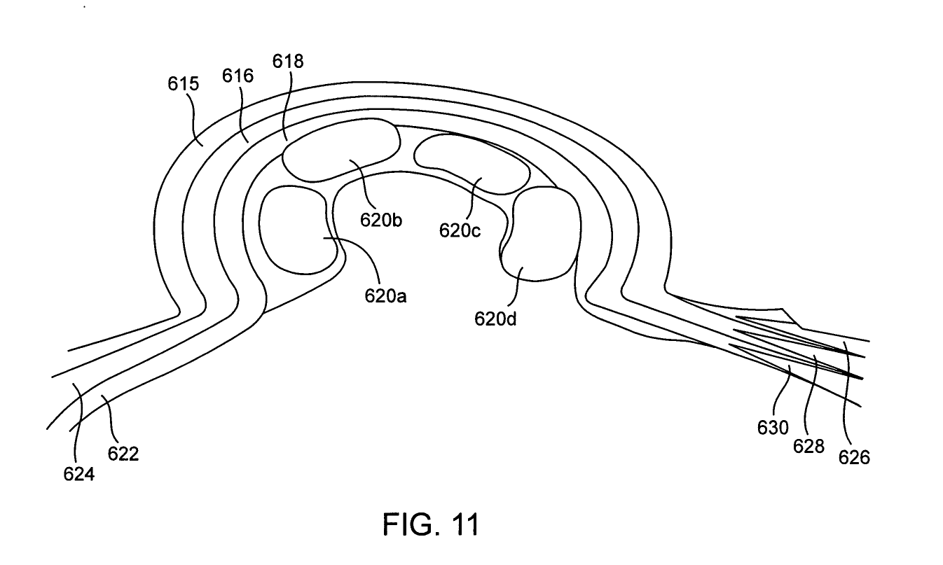

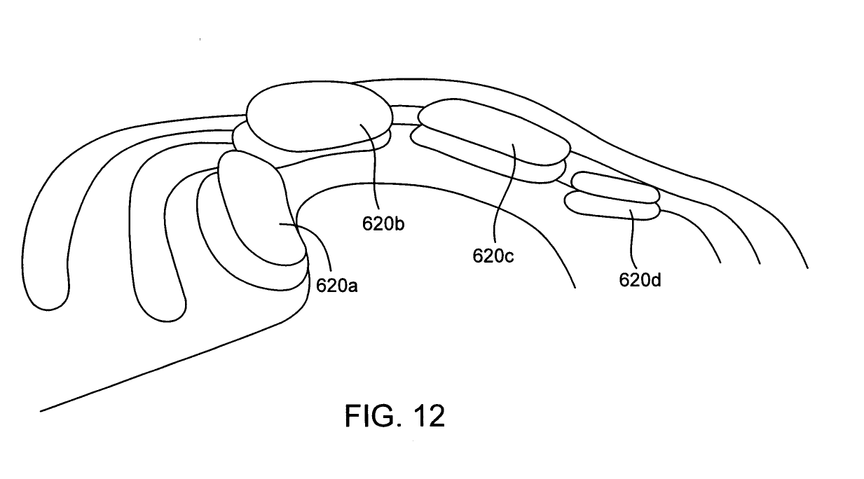

As shown in FIGS. 7, 11 and 12, the massaging means and the expression means are inflated and deflated by a series of air channels extending throughout the device. As shown in FIG. 7, the massaging and expression means 610 include the massaging section 612 and the expression section 614, with the massaging means including, in this embodiment, three massaging annular rings 615, 616 and 618, with a plurality of opposing expression means shown here as kidney-shaped bellows 620a, 620b, 620c, and 620d. A pair of air passages 622 and 624 extend to each of the bellows to inflate and deflate the bellows to facilitate the expression of breast milk. Further, channels 626, 628 and 630 are fully connected to the massaging members so as to be able to inflate and deflate the massaging members as required. As shown in FIG. 11, multi-lumen tubes 626, 628 and 630 are used as the means to connect to the appropriate massaging bladder components. As shown in FIG. 12, the bladder components are shown in an inflated state with a slight bellows configuration.

In yet another embodiment, the expression means may include a heating means which may be provided by electrical heating or air heating so as to help facilitate the milk ejection reflex.

The collection sub-component may consist of two separate pieces that may be fastened together to form a nipple cover and collection bag. The nipple cover is reusable after cleaning and the collection bag is disposable. The nipple cover and collection bag provide a leakproof connection between the two components when they are connected, and the bag may be fastened to or otherwise connected to both the breast receptacle and the nipple cover to provide the leak free connection. The collection device may include a valve that is activated by vacuum pressure and the opening of the valve may result in the vacuum and the milk tubing which brings milk into the collection bag. When the control vacuum is removed and positive pressure is applied, the valve will close and provided an in line one-way valve which prevents milk back flow from the bag. The opposite end of the bag is made to be a tearway end that simulates the top of the bottle when inserted into the baby's bottle, wherein the end folds over the edge of the bottle and is secured by a nipple attachment. The collection bags with milk may be sealed and stored or immediately placed in the baby's bottle for use. In this embodiment, the bags are disposable after one use.

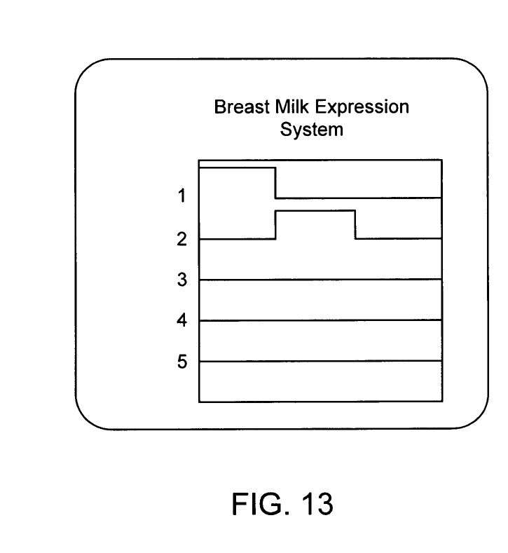

FIG. 13 illustrates a screen shot of the timing cycle of the inflation and deflation of the components, with annular ring 1 being cycled after annular ring 2.

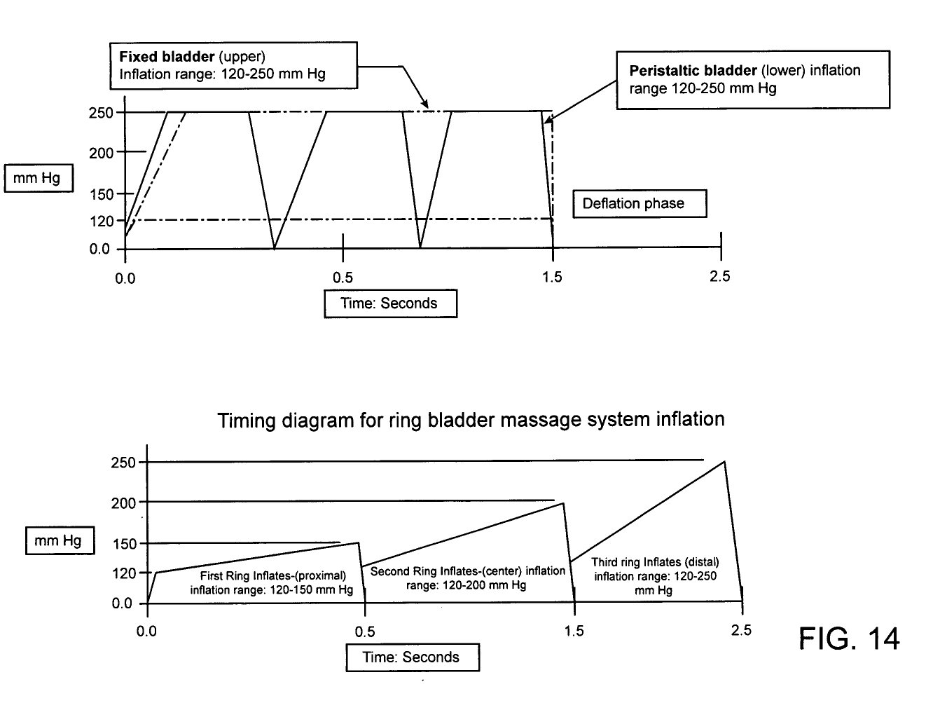

FIG. 14 illustrates timing diagrams for the inflation and deflation of the massage means and the expression means. These cycles may be adjusted by frequency, intensity and duration as provided by a control mechanism. The control mechanism may be a small lightweight wearable instrument that controls the operation of the expression system. The control component is portable and includes rechargeable batteries that are recharged with an AC adapter. A small LCD with integrated status LEDs allow for easy operation and enable the user to monitor operation of the device at all times. Switches control the user's selectable operation protocol and the device has memory capability to retain and repeat operating protocols that the user finds best for her breast milk expression sessions. The outer case of the control unit is rugged and impact resistant, as well as water resistant. When operating, the control unit is near silent so as not to detract from the expression session. The control unit uses a microprocessor that monitors the safety and alarm circuits for internal diagnostics.

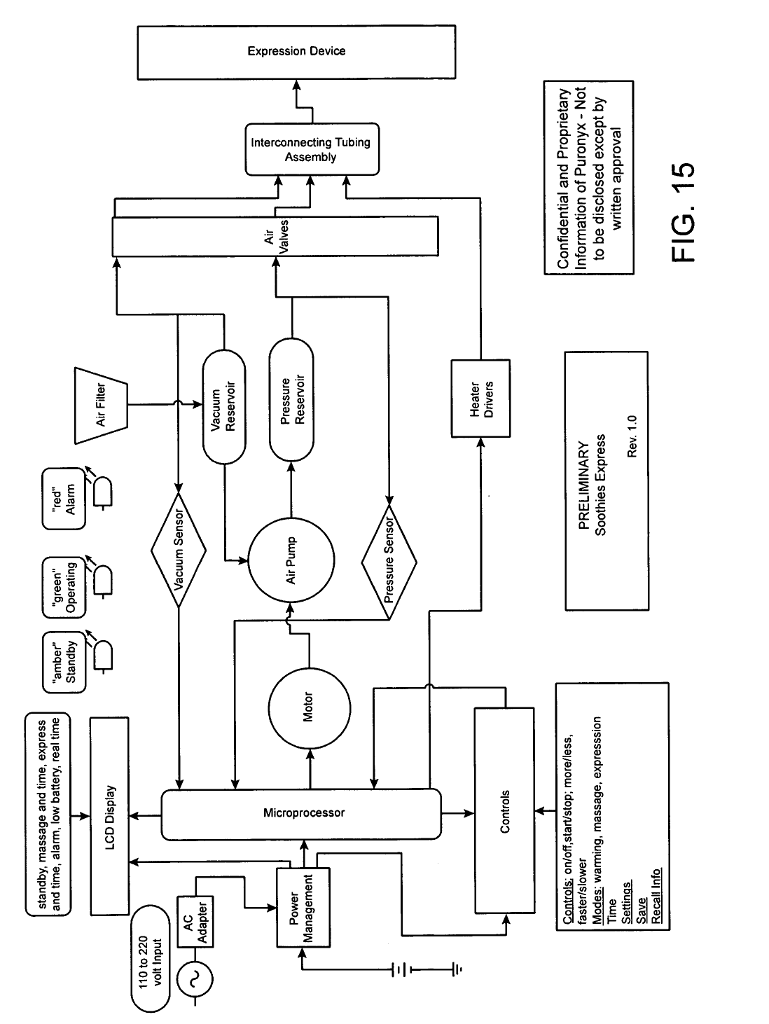

As shown in FIG. 15, a broad diagram illustrates the components of one embodiment of the control unit of the present disclosure. At power turn on, the control unit will go through a self-check, and the LCD display will show a message that goes from self-check to ready. When the ready is shown the amber LED will come on, and the operator can select either massage or express modes. When the massage mode is selected, a default massage cycle will begin and the appropriate components, including the warming pads, if any, in the massage means will inflate and deflate for the typical massage cycle. A green LED will then be illuminated and the display will show the message “massage” and the massage means will continue to operate until the cycle ends, and the massage cycle stops or the user selects an express key. The user controls the running time for the massage, and the unit can run the ideal massage time utilized by the user by use of a microprocessor, so that operation may become automatic and custom for that user. The massage cycle can be stopped at any time or the express cycle may be selected at any time to begin the milk expression cycle. When the expression cycle is selected, expression means is inflated in such a way to create the peristaltic wave-type motion to express milk from the breast. When the expressed mode starts, the peristaltic motion and frequency will use the default cycle. The user may modify the default protocol by selecting a different frequency for the peristaltic wave, or by selecting a different intensity regarding the amount of deflection of the appropriate expression means. The changes to the default protocol are by the user, and can be learned by the microprocessor so that her operation pattern can be saved and may be repeated at the next milk expression session. It is highly desirable to have this information available for downloading to an external device for documentation and confirmation of operational mode usage. Operation of the collection valve which draws milk down into the collection bag is activated sequentially with each expression cycle where milk is detected at a milk sensor that may be provided in the device. The control may include alarms or chimes that provide an audible tone. In addition, audible tones may be provided if an alarm condition exists, such as a low battery or a leak detected in the system.

The breast milk expression system of the current disclosure has distinct operational modes available for use, giving each breastfeeding mother unique programmable flexibility. The featured operational modes include labor augmentation, induced lactation, early post-partum, and established expression. Each of the operational modes of the system fit unique and varied needs of particular mothers. For example, labor augmentation is used by women requiring a natural hormonal augmentation to facilitate the labor process and provides prevention of post-partum hemorrhage following delivery. Induced lactation is best used by women choosing to establish lactation when the baby is not available, such as in the instances of adoption, premature or compromised infants, or suppressed milk volumes and re-lactation. The early post-partum operational mode is best used by women requiring assistance to relieve engorgement or plugged ducts, or facilitating latching.

The established expression mode is best used by women choosing to maintain lactation when separated from a baby, such as a situation where a woman has to work at a location while separated from the baby, or women incorporating alternative methods of feeding into their nursing style or to provide a gentle and effective milk expression for times of nipple soreness.

In the labor augmentation mode, the massaging means utilizes the massaging bladders to rhythmically fill and release in opposing patterns, creating a peristaltic wave-like massaging motion. The massage bladders sequentially fill from the edge furthest from the nipple toward the edge closest to the nipple, and fill in a selected volume within approximately 0.25 seconds, and hold the pressure constant while the sequential bladder fills to its volume within approximately 0.25 seconds. Both bladders hold the inflation for approximately 1.25 seconds, then spontaneously deflate within approximately 0.125 seconds. Deflation will occur in both bladders completely and equally in each cycle. Then there is an approximately 0.125 second pause prior to the pattern repeating. Fill patterns of the opposing bladders can be set to be a regular repeating pattern or a random fill pattern to optimize alveolar and ductal stimulation desired by the mother to facilitate and augment her labor. These patterns have the ability to be programmed to loop for up to sixty minutes in total and the patterns may be interrupted at any time during the duration of the cycle as desired or needed.

In the induced lactation mode, typically the breastfeeding mother would initiate the first expression within an hour of delivery to establish lactation. Stimulation then continues on a regular basis, utilizing the breast milk expression system of the current disclosure for 10 to 12 times each day until the baby is exclusively breastfeeding. This routine assures the appropriate stimulation necessary to establish lactation.

In the early postpartum mode of operation, the baby and mother are learning to master the art of breastfeeding, and there are several times that extra stimulation may be required to facilitate their success. The effective expression means assures adequate draining of the breast's ductal structures which helps mothers prevent or resolve engorged breasts.

The established expression mode assists women who return to work outside the home, yet who desire to continue breastfeeding. The breast milk expression system of the present disclosure provides near silent, discrete, programmable expressers that create the flexibility that mothers demand in their active lives while still incorporating milk expressions that are required to maintain a good milk supply whenever separated from the baby for whatever reason.

Although this disclosure has been shown and described with respect to detailed embodiments, those skilled in the art will understand that various changes in form and detail may be made without departing form the scope of the claimed disclosure.

1. A system for expressing milk from a human breast, comprising: a control system adapted to be worn by a user; a massaging means adapted to be located posterior to the areola; an expression means adapted to be located in the vicinity of the areola; and containment means adapted to contain the expressed milk.

2. The system of claim 1, wherein the massaging means and the expression means are operated independently by a control system.

3. The system of claim 1, wherein the massaging means comprises a series of inflatable rings, and a plurality of bladders with an open section in the cone with adjustable fasteners such as Velcro sides to facilitate placement around the breast and to accommodate different size breasts and breast conditions.

4. The system of claim 3, wherein the bladders are pneumatically operated.

5. The system of claim 4, wherein the bladders may be inflated and deflated by pneumatic operation.

6. The system of claim 3, wherein the massaging bladders are generally arranged in an annular manner.

7. The system of claim 3, wherein the massaging bladders are generally arranged in a linear manner.

8. The system of claim 2, wherein the expression means are pneumatically operated.

9. The system of claim 8, wherein the expression means are pivotable about a secured point.

10. The system of claim 9, wherein the expression means are generally in the shape of a bellows.

11. The system of claim 10, wherein the expression means is adapted to apply forward pressure or movement against the breast.

12. The system of claim 11, wherein the pressure is applied adjacent to the areola.

13. The system of claim 8, wherein the expression means comprises a plurality of expandable and deflatable bellows.

15. The system of claim 14, wherein the bellows provide biomimically of hand expression or infant sucking.

16. The system of claim 1, wherein the containment means includes sterile or pre-sterile, detachable containers.

17. The system of claim 1, wherein the containment means include pre-sterile disposable containers.

18. The system of claim 1, wherein the system is automatically operated.

19. The system of claim 1, wherein the system may be automatically operated at predetermined intervals.

20. The system of claim 1, wherein the system includes components that are adjustable with several variables that may include intensity, duration and frequency and wherein expression and massage patterns may be saved to memory so that a specific massage, expression, and containment session may be repeated, stored, and retained for possible download for medical documentation.

21. The system of claim 1, wherein the system is incorporated into a wearable garment.

22. The system of claim 1, wherein the system is incorporated into a bra garment.

23. The system of claim 1, wherein the system is battery operated and portable.

24. The system of claim 23, wherein the battery is rechargeable.

25. The system of claim 1, wherein the system includes a controller that is worn at the mother's waist and is the size of a small electronic device, such as a cell phone.

26. The system of claim 25, wherein the controller controls the different components to simulate hand expression and an infant's suckling movements.

27. The system of claim 26, wherein the controller includes software that provides commands to the controller.

28. The system of claim 1, wherein the system is adapted to express milk from one breast at a time.

29. The system of claim 1, wherein the system is adapted to express milk from both breasts at one time.

30. The system of claim 1, wherein the system is adapted to express milk alternatively from each breast.

31. The system of claim 1, wherein the system is operated either independently or in combination by means of components or sub-components that are operated pneumatically, mechanically or hydraulically.

32. The system of claim 1, wherein the system includes a heating means to assist in eliciting a milk ejection reflex.

33. The system of claim 1, wherein the system provides a containment means adapted to contain the expressed milk and further may be used for storage and for delivery of the stored breast milk to the infant.

34. A method of expressing milk, comprising the steps:
massaging a location posterior to the areola of the user; and
expressing breast milk by exerting pressure in the vicinity of the areola of the user; and
containing the expressed breast milk.

35. The method of expressing milk of claim 34, wherein the massaging step occurs prior to the expression step.
